(19) United States
(12) Patent Application Publication
(10) Pub. No.: US 2015/0000194 A1
(43) Pub. Date: Jan. 1, 2015

(54) HYDROPONIC FODDER GROWING SYSTEM

(71) Applicant: Luke A. Meerman, Coopersville, MI (US)

(72) Inventor: Luke A. Meerman, Coopersville, MI (US)

(21) Appl. No.: 14/317,073

(22) Filed: Jun. 27, 2014

Related U.S. Application Data
(60) Provisional application No. 61/840,044, filed on Jun. 27, 2013.

(51) Int. Cl. A01G 31/04

(52) U.S. Cl. CPC A01G 31/04
USPC 47/62 R

(57) ABSTRACT

A hydroponic fodder growing system includes a plurality of upright support members. A plurality of shelves are movably mounted to the upright support members for movement between a generally horizontal position and a tilted position. Each shelf defines a lower side edge when in the tilted position. The system also includes a water supply system that is configured to supply water to fodder disposed on the shelves. A powered conveyor extends below the lower side edges of the shelves when the shelves are tilted, whereby fodder falls off the shelves onto the powered conveyor when the shelves are in the tilted position.

### CROSS-REFERENCE TO RELATED APPLICATION

This application claims the benefit of U.S. Provisional Application No. 61/840,044 filed on Jun. 27, 2013, entitled, HYDROPONIC FODDER GROWING SYSTEM, the entire contents of which are incorporated herein by reference.

### BACKGROUND OF THE INVENTION

Various types of hydroponic growing systems have been developed. Barley, oats, wheat, and other grains can be hydroponically sprouted to provide increased food value for livestock or other applications. However, known hydroponic growing techniques may require significant labor to achieve, thereby creating difficulties for farmers or other parties wishing to utilize hydroponic fodder growing techniques.

### SUMMARY OF THE INVENTION

One aspect of the present invention is a hydroponic fodder growing system including a plurality of upright support members. A plurality of shelves are movably mounted to the upright support members for movement between a generally horizontal position and a tilted position. Each shelf defines a lower side edge when in the tilted position. The system also includes a water supply system that is configured to supply water to fodder disposed on the shelves. A powered conveyor below the lower side edges of the shelves when the is configured to transport fodder after it is removed from the shelves.

### BRIEF DESCRIPTION OF THE DRAWINGS

FIG. 1 is a partially schematic elevational view of a building including a hydroponic growing system according to one aspect of the present invention;

FIG. 2 is a top plan view of the building and hydroponic growing system of FIG. 1;

FIG. 3 is a view of the building and hydroponic growing system of FIG. 2 taken along the line III-III;

FIG. 4 is a cross sectional view of the hydroponic growing system of FIG. 2 taken along the line IV-IV;

FIG. 5 is an enlarged view of a tiltable shelf of FIG. 4;

FIG. 5A is an enlarged view of a tiltable shelf according to another aspect of the present invention;

FIG. 5B is an enlarged view of a tiltable shelf according to another aspect of the present invention;

FIG. 5C is partially fragmentary view of a tiltable shelf support according to another aspect of the present invention;

FIG. 5D is a partially fragmentary view of the shelf support of FIG. 5B;

FIG. 6 is a partially fragmentary elevational view of a tiltable shelf of FIG. 4;

FIG. 7 is a cross sectional view of the shelves of FIG. 2 taken along the line VII-VII;

FIG. 8 is a cross sectional view of shelf edges according to another aspect of the present invention; and

FIG. 9 is a cross sectional view of a portion of the conveyor belt system.

### DETAILED DESCRIPTION

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

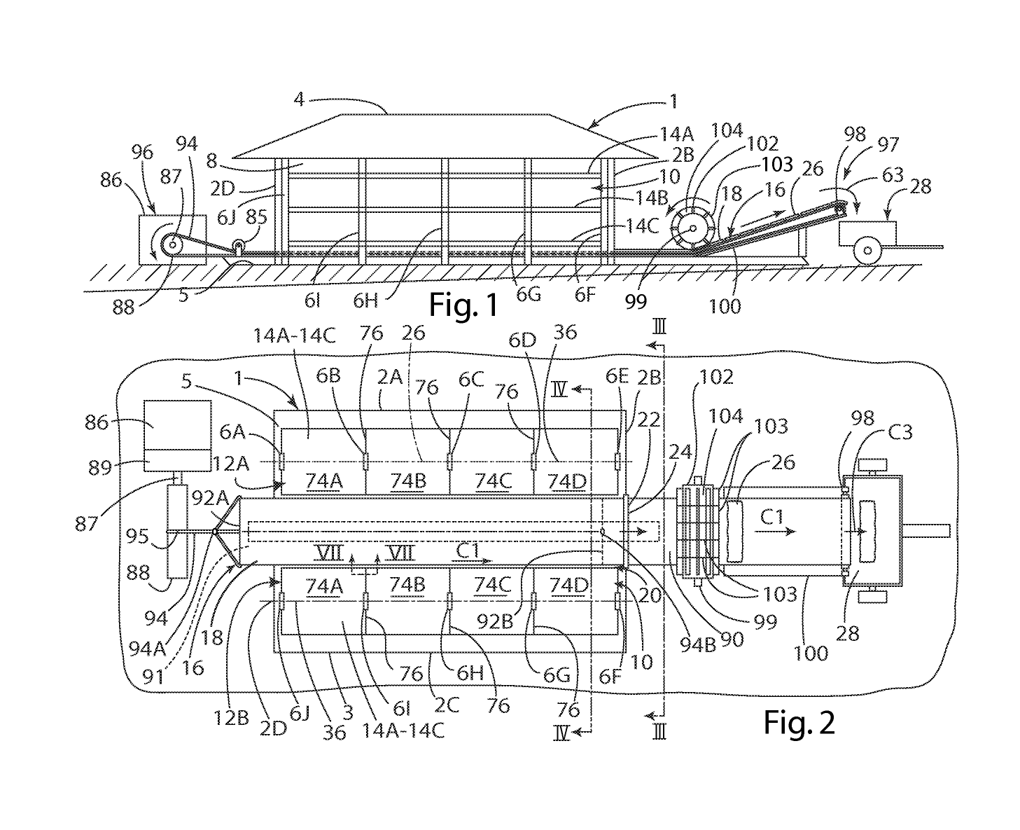

With reference to FIGS. 1 and 2, a building 1 includes sidewalls 2A-2D forming a generally rectangular perimeter 3 in plan view (FIG. 2). The building 1 may include a roof 4 that is supported by sidewalls 2A-2D and a plurality of uprights 6A-6J. Building 1 further includes a floor 5 that may comprise concrete or other suitable material. Building 1 may also include a heating and/or air conditioning system (not shown) to maintain the interior 8 at a desired temperature. The building 1 may also include a plurality of interior lights (not shown) to allow a user to see inside the building 1, and the lights may also be utilized (if required) to assist in growing plants inside the building 1.

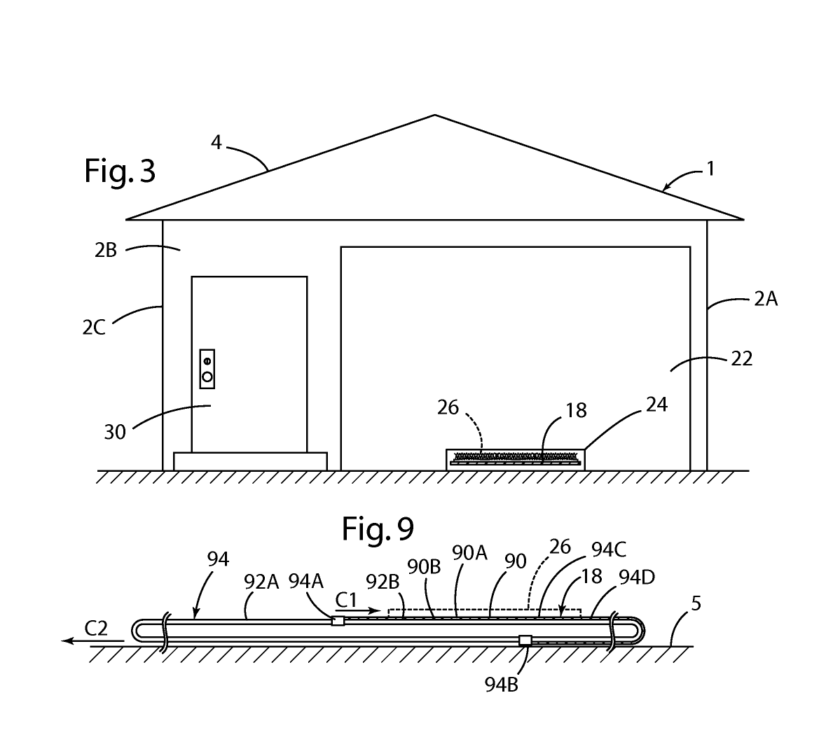

As discussed in more detail below, a hydroponic growing system 10 includes first and second rows 12A and 12B (FIG. 2) of shelves 14. The rows 12A and 12B include upper shelves 14A (FIG. 1), intermediate shelves 14B, and lower shelves 14C. It will be understood that fewer shelves or additional shelves may be utilized as required for a particular application. With reference to FIG. 2, the first and second rows 12A and 12B, respectively, of shelves are spaced-apart to form an elongated central space 20. A powered conveyor system 16 includes a conveyor belt 18 disposed in the central space 20 between the rows of shelves 12A and 12B. As discussed in more detail below, conveyor belt 18 extends through an opening 24 (see also FIG. 3) in a door 22, and transports sprouted seeds or sod 26 to a trailer 28 or other transport device to provide for transport of the fodder/sod 26 to remote locations for feeding cattle or other uses. With reference to FIG. 3, door 22 may comprise a garage door or the like, and the building 1 may include one or more additional doors 30 to provide access to the interior 8 of building 1.

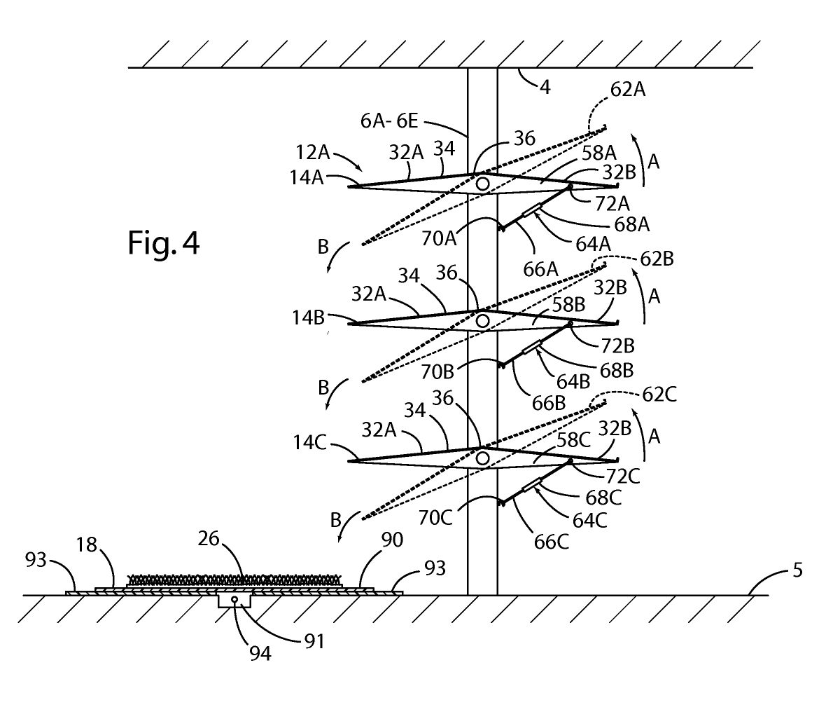

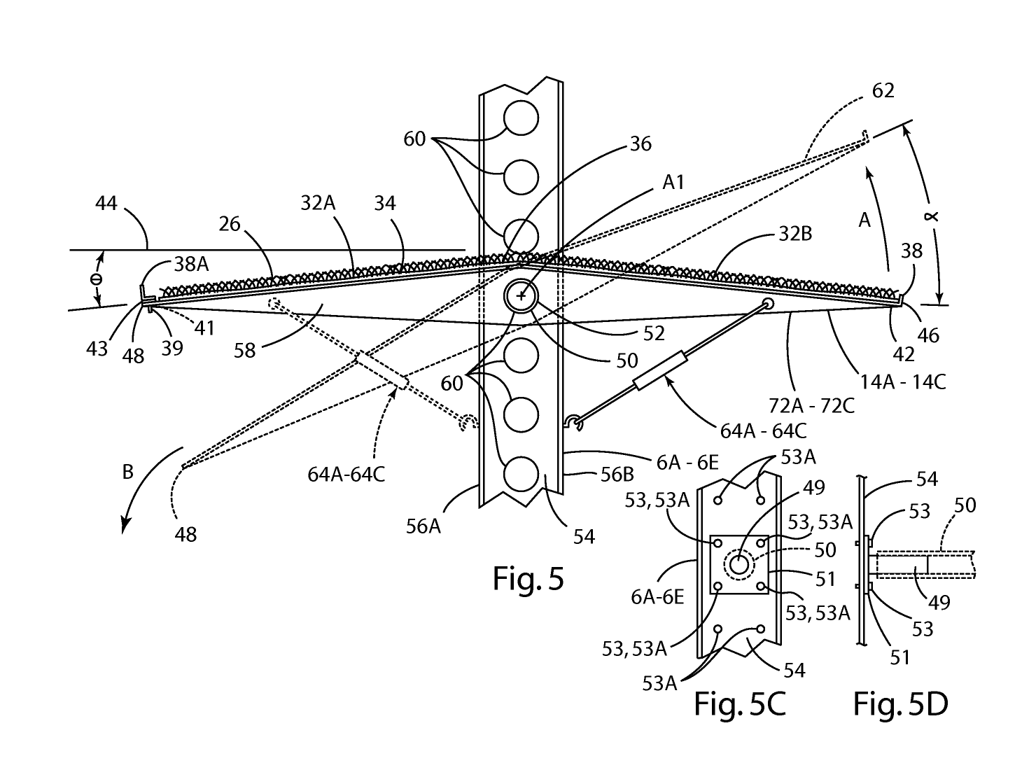

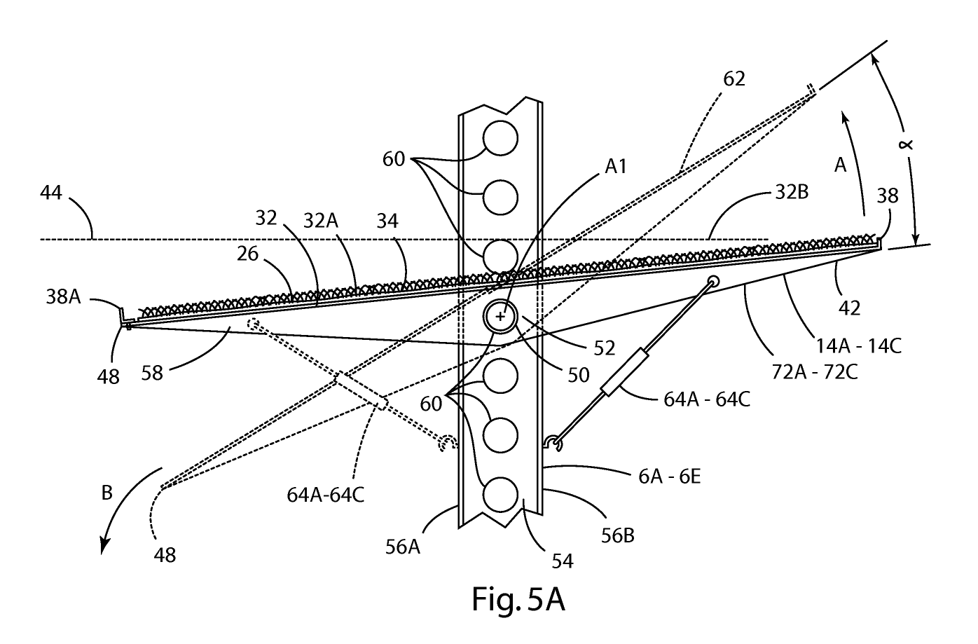

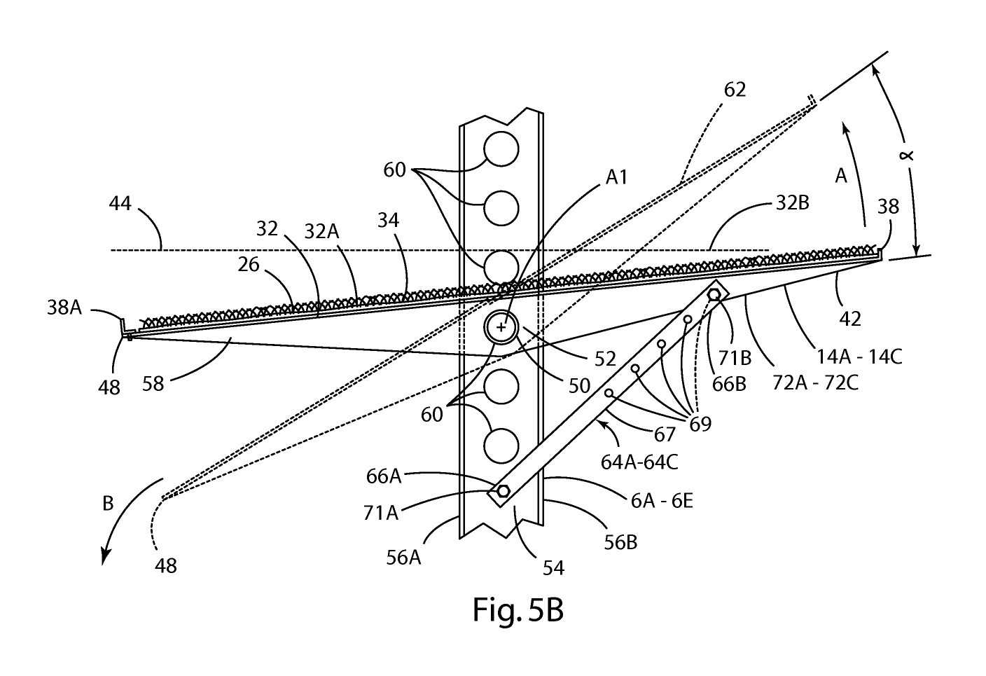

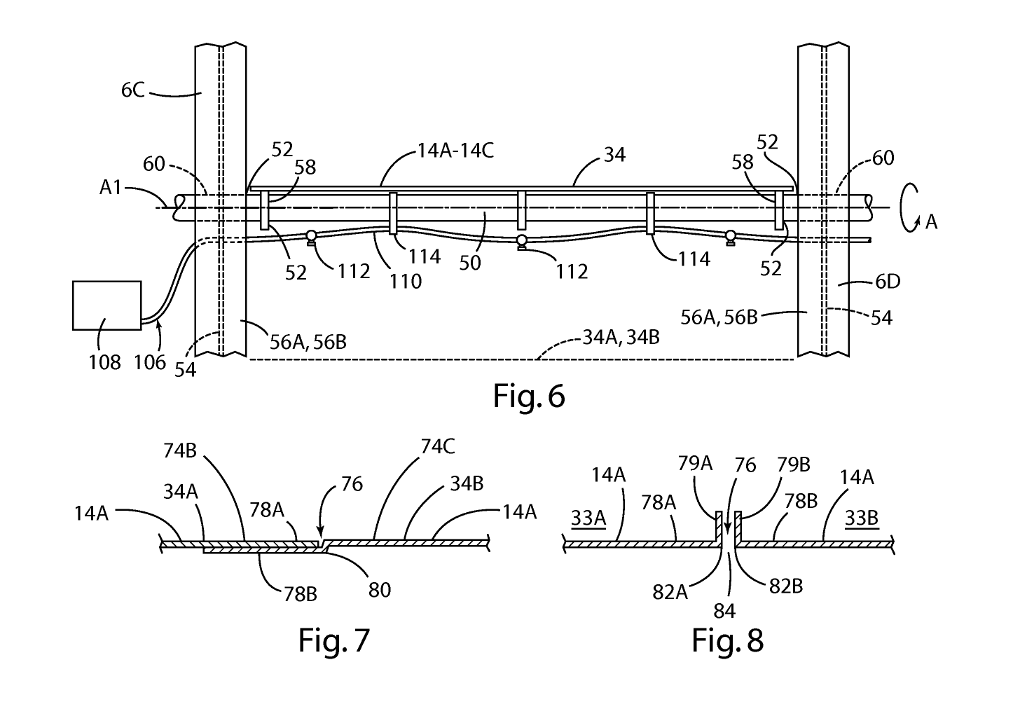

With further reference to FIG. 4, in the illustrated example row 12A includes shelves 14A-14C that are rotatably interconnected to uprights 6A-6E. Uprights 6A-6E rotatably support the shelves 14A-14C and may also provide structural support for roof 4 of building 1. With further reference to FIGS. 5 and 6, each shelf 14A-14C includes a sheet 34 having first and second generally planar growing surfaces 32A and 32B. The planar growing surfaces 32A and 32B are angled relative to one another to define a shallow upside down V shape when viewed from an end of the shelves as shown in FIG. 5. The growing surfaces 32A and 32B intersect to form a raised ridge at a central portion 36. The growing surfaces 32A and 32B may be disposed at a small angle θ relative to a horizontal plane 44 to thereby provide for drainage of water utilized to irrigate the sod 26. In general, the angle θ is preferably about 1° to about 10°. An upwardly extending lip 38 (FIG. 5) may extend along a rear edge 42 of growing surface 32B to ensure that sod 26 does not fall off edge 42 of growing surface 32B. Optionally, lip 38 may include one or more openings 46 therethrough to permit drainage of water from growing surface 32B along rear edge 42. Shelves 14A-14C may also include a lip 38A that extends along front edge 48. Lip 38A is optionally a removable member that is L-shaped in cross section, and includes a plurality of pins 39 that extend through openings 41 in sheet 34 to connect removable lip 38A to sheet 34. A gasket 43 comprising a thin layer of elastomeric material may be positioned between removable lip 38 and sheet 34 to form a watertight seal. Pins 39 may optionally comprise threaded studs that receive threaded nuts (not shown) to secure removable lips 38A to sheet 34 and compress gasket 43. Alternatively, lip 38A may comprise an integral (non-removable) flange formed by bending/folding sheet 34. Growing surface 32B may be oriented such that edge 42 is elevated above center portion 36, such that water from growing surface 32B drains onto growing surface 32A, and then drains off the shelf 14A-14C along front edge 48.

Referring again to FIG. 5, the shelves 14A-14C include gussets 58 that may comprise a relatively thin sheet of material. The gussets 58 and the sheets 34 may comprise stainless steel, aluminum, or other corrosion resistant material. The gussets 58 may be welded to sheet 34. The sheet 34 and/or gussets 58 may also comprise a polymer material or other suitable corrosion resistant material. An elongated tube 50 extends through openings 52 in gussets 58. The tubes 50 may be welded to gussets 58, and the tubes 50 may comprise substantially the same material as gussets 58 and sheet 34. Uprights 6A-6E may be I-shaped or C-shaped in cross section with a central wall 54 (see also FIG. 6), and end walls 56A and 56B. The tubes 50 also extend through openings 60 in central walls 54 of uprights 6A-6E to thereby rotatably mount the shelves 14A-14C to the uprights 6A-6E to thereby permit rotation of shelves 14A-14C in the direction of the arrow “A” (FIGS. 5 and 6) about a horizontal axis “A1”. Uprights 6A-6E may include vertical rows of openings 60 that are relatively closely spaced apart (e.g. 3 inches, 6 inches, or 12 inches) to permit shelves 14A-14C to be vertically positioned at a specific height as required for a particular application. Also, the vertical spacing between shelves 14A-14C and the number of shelves can be adjusted/set by mounting the shelves to selected ones of the openings 60 as required.

Alternatively, with reference to FIGS. 5C and 5D, tubes 50 may be rotatably supported on enlarged pins 49 that are welded to plates 51. Plates 51 are secured to central wall or web 54 of uprights 6A-6E utilizing threaded fasteners 53 that extend through openings 53A in plates 51 and webs 54. Uprights 6A-6E may include a plurality of vertically spaced groups of openings 53A to permit shelves 14A-14C to be mounted at selected vertical positions. For example, the openings 53A may be vertically spaced apart to provide vertical mounting of shelves 14A-14C at locations that are vertically spaced apart at 3 inch, 6 inch, or 12 inch increments. When the shelves 14A-14C are rotated from a generally horizontal growing position to a tilted position shown in dashed lines and designated 62 in FIG. 5, sod 26 slides off surfaces 32A and 32B as shown by the arrow “B” (FIG. 5), and the sod 26 then lands on conveyor belt 18 (FIG. 4) so it can be transported out of the building 1. If tilt angle α (FIG. 5) is large enough, gravitational forces are sufficient to cause the sod 26 to slide off growing surfaces 32A and 32B. However, a rake or the like (not shown) may also be utilized to manually assist removal of the sod 26 from growing surfaces 32A and 32B. Tilt angle α is preferably at least about 20° to facilitate removal of sod 26.

With reference to FIG. 5A, shelves 14A-14C may, alternatively, have a single planar sheet 34 such that growing surfaces 32A and 32B comprise first and second portions of a single planar upper surface 32. The shelves 14A-14C may be set at an angle θ1 relative to a horizontal plane 44 utilizing mechanisms 64A-64C to provide for drainage of water from edge 48. Mechanisms 64A-64C can be utilized to adjust the angle θ1 as required.

Referring again to FIG. 4, retaining devices 64A-64C may be utilized to selectively retain the shelves 14A-14C in the “horizontal” growing position (The term “horizontal” in this context refers to a growing position that may include a relatively small slope for drainage as discussed above). The growing surfaces 32A and 32B may be substantially the same size and shape. Alternatively, the growing surface 32A may be somewhat larger than the growing surface 32B, such that the additional weight on growing surface 32A biases the shelves 14A-14C to the tilted positions 62A-62C (i.e. shelves 14A-14C are biased counter clockwise in FIG. 4). Additional weights, springs or other biasing devices (not shown) may also be utilized to bias the shelves 14A-14C towards the tilted position. In the illustrated example, the retaining devices 64A-64C comprise straps, cables or chains 66A-66C and a lever operated chain shortening/tensioning mechanism 68A. Opposite ends 70A-70C and 72A-72C of retaining devices 64A-64C are connected to uprights 60A-60E and to gussets 58 of shelves 14A-14C, such that the retaining devices 64A-64C selectively retain the shelves 14A-14C in their respective horizontal growing positions. The ends 70 and 72 may include hooks or other connectors (not shown) that are received in openings of uprights 6A-6E and gussets 58A-58C, such that the chains 66 can be readily disconnected from uprights 6A-6E and/or shelves 14A-14C to permit rotation of shelves 14A-14C from the growing position to the tilted positions 62A-62C. Retaining devices 64A-64C may be positioned on both sides of uprights 6A-6E to thereby adjustable secure the shelves 14A-14C at a desired angle. Biasing weights or mechanisms are typically not required if devices 64A-64C are positioned on both sides of uprights 6A-6E.

The mechanisms 68A-68C may comprise known lever and ratchet mechanisms that can be utilized to adjust the lengths of the chains 66 to thereby adjust the angle of the shelves 14A-14C when the shelves 14A-14C are in the growing position. It will be understood that the present invention is not limited to these types of retaining devices. Various other types of mechanisms may be utilized to selectively retain the shelves 14A-14C in the growing position, and to selectively release the shelves 14A-14C to permit rotation of the shelves 14A-14C to the tilted positions 62A-62C. For example, with reference to FIG. 5B, devices 64A-64C may comprise straps 67 having a plurality of holes 69. A fastener 71A connects first end 66A of strap 67 to post 6, and a fastener 71B connects a second end 66B of strap 67 to shelf 74. Fasteners 71A and 71B may comprise threaded fasteners or other suitable connectors. Fastener 71B can be received in a selected one of the holes 69 to thereby retain shelf 74 at a selected angle.

With reference to FIG. 6, the hydroponic growing system 10 may include an irrigation system 106 including a water supply 108 and a plurality of lines 110 that extend along tubes 50. The lines 110 may be secured to tubes 50 by one or more straps 114 or other suitable connectors. In use, water from water source 108 is distributed through lines 110 to a plurality of spray heads 112 that spray the water onto the growing surfaces 32A and 32B of the shelves 14A-14C. The irrigation system 106 may comprise commercially available components, such that further details concerning irrigation system 106 are not believed to be required.

Referring again to FIG. 2, each of the shelves 14A-14C includes a plurality of individual shelves 74A-74D disposed between uprights 6A-6F. Each of the individual shelves 74A-74D is independently rotatable. Thus, in the illustrated example, each shelf 14A includes four separate growing areas 74A-74D that can be tilted to remove the sod 26. Each row 12A and 12B includes a total of 12 individual growing areas 74 (shelves 14A, 14B, and 14C each include four individual growing areas 74A-74D), such that hydroponic growing system 10 includes a total of 24 individual growing areas 74. As discussed in more detail below, the seeds used to produce sod 26 may require several days to sprout sufficiently for feed purposes, and individual growing areas 74 may be utilized to accommodate seeds at various stages of the sprouting/growing process to thereby provide a continuous supply of sod 26.

Referring again to FIG. 2, joints 76 are formed between adjacent growing areas 74A-74D. With further reference to FIG. 7, joints 76 may comprise overlapping edge portions 78A and 78B of adjacent sheets 34A and 34B of adjacent growing areas 74B and 74C of a shelf 14A. Sheet 34B may include an offset bend 80 such that edge portion 78B is offset to provide a smooth joint 76 whereby the adjacent surfaces 74B and 74C are substantially coplanar. It will be understood that the overlap of portions 78A and 78B may be “reversed” on opposite sides of the center portion 36 to permit rotation of growing areas 74B relative to growing areas 74C.

With further reference to FIG. 8, in an alternative embodiment edges 82A and 82B of edge portions 78A and 78B may be spaced apart to form a gap 84 at joint 76. Edges 82A and 82B may include upwardly extending lips 79A and 79B, respectively, to retain water within growing surfaces or areas 32A and 32B. The lips or sidewalls 38, 38A (FIGS. 5, 5A) and 79A, 79B may form shallow, upwardly opening cavities 33A, 33B that retain water to facilitate growth of sod or fodder 26. Also, after removal of sod 26, a water and chlorine mixture may be introduced into the cavities 33A, 33B utilizing irrigation system 106 (FIG. 6) to sanitize the growing areas 32A, 32B. After a period of time (e.g. 10 minutes) the water and chlorine can be drained, and water from irrigation system 106 or other water supply can be utilized to rinse the growing areas 32A, 32B. Seeds can then be spread on growing areas 32A, 32B and additional water can be introduced to initiate the growing process. The joints 76 of FIG. 7 or FIG. 8 may be utilized as required for a particular application.

Referring again to FIGS. 1 and 2, powered conveyor system 16 includes an electrically powered drive unit 86 having an output shaft 87 and a pulley 88 that is fixed to the shaft 87. The electrically powered drive unit 86 may comprise an electric motor and a gear drive 89 that provides the proper rotational velocity for pulley 88. Conveyor belt 18 comprises an elongated flexible sheet of material 90 (see also FIG. 9) having first and second ends 92A and 92B. A cable 94 forms an elongated loop, and includes first connector 94A that is connected to first end 92A of flexible belt 90, and a second connector 94B that is connected to second end 92B of flexible belt 90. As shown in FIG. 9, portions 94C and 94D of cable 94 extend under flexible belt 90. An optional channel 91 (see also FIG. 4) in floor 5 receive portions of cable 94 such that belt 90 slides on floor 5. Sheets 93 of low friction polymer or other suitable material may be positioned on floor 5 adjacent channel 91 whereby belt 90 slides on sheets 93. Cable 94 forms several loops 95 around pulley 88 to thereby prevent slippage of cable 94 about pulley 88. The cable 94 passes under a roller 85 (FIG. 1) to thereby position the cable 94 and belt 90 adjacent the floor surface 5. The belt 90 and cable 94 together form an elongated loop having a first portion 96 that extends around pulley 88, and a second portion 97 that extends around a roller 98 that is located outside building 1 on a ramp 100.

With further reference to FIG. 9, the flexible belt 90 comprises a suitable material such as a sheet of elastomeric material (e.g. rubber) that has been reinforced with metal strands. The elongated flexible belt 90 includes an upper portion 90A that is slidably disposed on top of a lower portion 90B. The upper and lower portions 90A and 90B are shown in a spaced-apart relationship with respect to one another in FIG. 9. However, it will be understood that, in use, upper portion 90A is typically in sliding contact with lower portion 90B.

In use, after tilting of shelves 14A-14C to move sod 26 onto upper portion 90A of belt 90, electrically powered drive unit 86 is initially actuated by pushing an actuator button or the like (not shown). Electrically powered drive unit 86 rotates pulley 88 to thereby pull on cable section 94B in the direction of the arrow “C2”, thereby causing the upper portion 90A of flexible belt 90 to move in the direction of the arrow “C1”. As the elongated flexible belt 90 moves, lower portion 90B slides on floor 5 in the direction of the arrow C2, and upper portion 90A of belt 90 slides on lower portion 90B of belt 90 in the direction of the arrow C1. As discussed above, the floor 5 and/or belt 90 may have an abrasion resistant surface (e.g. sheets 93, FIG. 4) that is relatively low friction to facilitate sliding of these components relative to one another. Floor 5 may include rollers or the like (not shown) to further reduce friction between the lower belt portion 90B and floor surface 5.

As the sod 26 is transported on belt 90 in the direction of the arrow C1 (FIG. 2), the sod 26 exits building 1 through opening 24 (see also FIG. 3) in door 22. The belt 90 passes under a roller 98 disposed outside of building 1, and travels up ramp 100. Roller 104 may be generally cylindrical, and it may include a plurality of blades 2 extending parallel to axis 99 of roller 104, and a plurality of circular blades 103 extend transversely relative to blades 102. Blades 102 and 103 are optional, and roller 104 may include only blades 102, only blades 103, or both blades 102 and 103. Blades 102 and/or 103 cut the sod 26 into discreet strips or pieces to facilitate handling and use of the sod 26. In the illustrated example, flexible belt 90 is about 3 feet wide, and the blades 2 of roller 104 may be spaced apart approximately 4″. Blades 103 may also be spaced apart approximately 4″ to thereby create a plurality of square pieces of sod 26 having a length and a width of about 4″.

A trailer 28 or the like may optionally be positioned below roller 98 at second end 97 of the loop 95 formed by belt 90 and cable 94, such that sod 26 falls into the trailer 28 as shown by the arrow “C3”. However, a trailer 28 is not required, and sod 26 may simply drop onto the ground below the second end 97 of belt 90.

Once the end 92A (FIG. 2) of belt 90 approaches the roller 104, all of the sod 26 will have been transferred to trailer 28. The conveyor system 16 may include one or more limit switches or the like (not shown) that are engaged and actuated by end 92B of belt 90 as the end 92A of belt 90 approaches roller 98. A controller (not shown) then turns off the electrically powered drive unit 86 to ensure that the end 92B of belt 90 does not come into contact with pulley 88, electrically powered drive unit 86, or other structures, and to prevent end 92A of belt 90 from contacting roller 104.

After the sod 26 has been transferred to trailer 28 and electrically powered drive unit 86 has been turned off, the electrically powered drive unit 86 can be actuated in a reverse direction such that the end 92A of belt 90 travels in a direction opposite the arrow C1 (FIG. 2) back to a “home” position as shown in FIG. 2. Limit switches or the like (not shown) may be configured to engage end 92A of belt 90 to thereby turn off electrically powered drive unit 86 once the belt 18 has reached the home position of FIG. 2. Once the belt 18 has returned to the home position of FIG. 2, it is ready to receive additional sod 26 from the shelves 14A-14C.

The barley, oat, wheat, or other seeds utilized to form sod (fodder) 26 may require several days of irrigation to sprout/grown and form suitable food for livestock and the like. Thus, individual growing areas 74 may include seeds that are at various stages of the germination and growth process. For example, if a particular type of seed requires six days to form suitable sod, the growing areas 74 of shelves 14A-14C may be divided into six equally-sized regions. In the illustrated example, the hydroponic growing system 10 includes a total of 24 individual growing areas 74 that can be divided into six regions, each including four individual growing areas 74A-74D. Once the sod 26 is ready to be removed from four individual growing areas 74A-74D, the four shelf sections can be tilted to slide the sod 26 off onto conveyor 18, and the sod 26 can then be removed utilizing the powered conveyor system 16 as described above. New seeds/grain can then be distributed on the four individual growing areas 74 that have just been cleared of sod 26, and the seeds can be and irrigated to begin the germination/growing process. In this way, individual growing areas can include seeds that have been growing for 0, 1, 2, 3, 4, 5, and 6 days. If the seeds require more time (e.g. 8 days) to grow sod (fodder) 26, more growing areas (e.g. 8) can be utilized. In general, the number of growing areas 74 is selected to be equal to the number of days required to grow the sod 26 to its desired final state/condition. The hydroponic fodder growing system of the present invention thereby permits a daily supply of sod 26 to be provided on a daily basis. Also, different types of seeds may be positioned on the shelves to simultaneously provide different types of sod 26. The number of growing areas allocated to each type of seed may be equal to the number of growing days required for each type of seed to thereby provide a continuous, daily supply of sod 26 of each type.

The hydroponic growing system 10 of the present invention provides a “turnkey” system that can be utilized by farmers or others requiring a daily supply of sod 26. The use of tilting shelves 14A-14C and powered conveyor system 16 greatly reduces the labor required to remove the sod 26.

The invention claimed is:

1. A hydroponic fodder growing system comprising:
a plurality of upright support members;
a plurality of shelves movably mounted to the upright support members for movement between a generally horizontal position and a tilted position, each shelf defining a lower side edge when in the tilted position;
a water supply system configured to supply water to fodder disposed on the shelves; and
a powered conveyor below the lower side edges of the shelves is configured to transport fodder that falls off the shelves onto the powered conveyor when the shelves are in the tilted position.

2. The hydroponic fodder growing system of claim 1, wherein:
the shelves are pivotably connected to the upright support members.

3. The hydroponic fodder growing system of claim 2, including:
a plurality of retainers releasably retaining the shelves in the generally horizontal positions.

4. The hydroponic fodder growing system of claim 3, wherein:
each shelf includes first and second opposite side edges and a lip that extends upwardly from the second side edge.

5. The hydroponic fodder growing system of claim 1, wherein:
each shelf includes first and second upper surface portions that extend at an angle relative to one another such that the shelves have a shallow upside down V-shape in cross section.

6. The hydroponic fodder growing system of claim 1, wherein:
the shelves are arranged in two parallel rows extending along opposite sides of the powered conveyor.

7. The hydroponic fodder growing system of claim 6, wherein:
each row of shelves includes at least one column of shelves comprising at least three vertically spaced apart shelves.

8. The hydroponic fodder growing system of claim 7, wherein:
each row of shelves includes at least two columns of shelves that are movably connected to an upright support member disposed between the two columns of shelves.

9. The hydroponic fodder growing system of claim 1, including:
a building structure having a roof and at least one sidewall, the building structure defining an interior space, and wherein the shelves are disposed within the interior space; and
the powered conveyor includes an interior portion disposed in the interior space and an exterior portion disposed outside of the building structure whereby fodder can be moved from the interior space to the exterior space by the powered conveyor.

10. The hydroponic fodder growing system of claim 9, wherein:
the conveyor comprises an elongated flexible belt forming a loop having first and second ends, and wherein the second end is disposed outside the building structure.

11. The hydroponic fodder growing system of claim 10, wherein:
the elongated flexible belt includes a generally horizontal first portion disposed inside the building structure and a ramped second portion at the second end that extends upwardly from the generally horizontal first portion.

12. The hydroponic fodder growing system of claim 11, wherein:
the second end of the elongated flexible belt is elevated whereby fodder falls off the second end.

13. The hydroponic fodder growing system of claim 10, including:
a cutter disposed above the elongated flexible belt to cut fodder on the elongated flexible belt.

14. The hydroponic fodder growing system of claim 13, wherein:
the cutter comprises a rotating member having a plurality of blades.

15. The hydroponic fodder growing system of claim 1, wherein:
the lower side edges of the shelves are positioned directly above the conveyor in vertical alignment therewith when the shelves are titled.
